(19) United States
(12) Patent Application Publication
(10) Pub. No.: US 2018/0031914 A1
(43) Pub. Date: Feb. 1, 2018

(54) LIQUID CRYSTAL DISPLAY DEVICE AND LIQUID CRYSTAL DISPLAY PANEL

(71) Applicant: Wuhan China Star Optoelectronics Technology Co., Ltd., Wuhan, Hubei (CN)

(72) Inventor: Chang XIE, Shenzhen, Guangdong (CN)

(73) Assignee: Wuhan China Star Optoelectronics Technology Co., Ltd., Wuhan, Hubei (CN)

(21) Appl. No.: 14/898,080

(22) PCT Filed: Dec. 3, 2015
(86) PCT No.: PCT/CN2015/096266

§ 371 Date: Dec. 11, 2015

(30) Foreign Application Priority Data
Nov. 25, 2015 (CN) 201510836023.0

(51) Int. Cl. G02F 1/1335; G02F 1/1343

(52) U.S. Cl. CPC G02F 1/133536; G02F 1/133553; G02F 1/133514; G02F 1/1343; G02F 1/133504; G02F 1/133602

(57) ABSTRACT

A liquid crystal display device and a liquid crystal display panel are disclosed. A polarizer sheet disposed at a side of the array substrate includes a polarizer base and a scattering layer. A reflective layer is located at a side of the polarizer sheet corresponding to the light reflective region. A reflection surface of the reflective layer adjacent to the polarizer sheet is a flat surface. The reflection surface is used to perform a specular reflection for an incident light. The scattering layer is used to perform a diffuse reflection for a light reflected by the reflection surface. The present invention can utilize less photomask processes to realize a transflective display effect so as to reduce the manufacturing processes, the manufacturing cost and ensure the reflection effect at the same time.

### BACKGROUND OF THE INVENTION

### 1. Field of the Invention

The present invention relates to a liquid crystal display technology field, and more particularly to a transflective liquid crystal display panel and a liquid crystal display device having the liquid crystal display panel.

### 2. Description of Related Art

Because the liquid crystal molecules cannot emit light, a liquid crystal display panel requires a light source to display an image. According to the type of the light sources, a liquid crystal display panel can be divided into a transmissive type, a reflective type or a transflective type. Wherein, the transmissive type liquid crystal panel utilizes a backlight source, and a pixel electrode is a transparent in order to facilitate a light passing through a liquid crystal layer to display an image. The reflective type liquid crystal panel utilizes a front light source or an external light source, and a reflective layer will reflect a light so that the light can pass through the liquid crystal layer to display an image. The transflective type liquid crystal display panel can be regarded as a combination of the transmissive type and the reflective type so that the transflective type liquid crystal display panel can utilize a backlight source, a front light source or an external light source at the same time to display an image.

The transflective type liquid crystal display panel has advantages of the transmissive type and the reflective type so that the transflective type cannot only display a bright image in a dark environment for an indoor use, but also be applied in an outdoor use. For obtaining an even reflection effect at every viewing angle for an observer, the reflective layer of the conventional transflective type liquid crystal display panel adopts a reflection method of diffuse reflection such that a reflection surface of the reflective layer has a concave and convex structure in order to realize the diffuse reflection. The manufacturing method of the reflective layer generally is: firstly, manufacturing a resin layer as a base, because the reflective layer only requires disposing at a reflective region, and not requires disposing at a transmissive region, an additional photomask is required; then, performing an exposure process, a development process, and an etching process in order to form a concave and convex structure on the resin layer; the process also requires an additional photomask process; finally, forming a reflective layer on the concave and convex structure.

It can be understood that the conventional art requires two photomask processes to manufacture the reflective layer so that the manufacturing process is more and the manufacturing cost is higher. Besides, the dimensional precision of the concave and convex structure for ensuring a diffuse reflection effect should be higher so that an error is easily to generate, which will affect the reflection effect.

### SUMMARY OF THE INVENTION

Accordingly, the technology problem solved by the embodiment of the present invention is to provide a liquid crystal display device and liquid crystal display panel, which can use less photomask processes to realize a transflective display effect in order to reduce the manufacturing processes, the manufacturing cost, and ensure the reflection effect at the same time.

The liquid crystal display panel provided by the embodiment of the present invention includes: an array substrate and a color filter substrate which are disposed oppositely and at an interval, wherein, the array substrate includes multiple light reflective regions and multiple light transmissive regions disposed alternately; a liquid crystal layer disposed between the array substrate and the color filter substrate; a first polarizer sheet disposed at a side of the array substrate, and disposed corresponding to the light reflective region and the light transmissive region, wherein, the first polarizer sheet includes a polarizer base and a scattering layer; and a reflective layer located at a side of the first polarizer sheet away from the array substrate, and disposed corresponding to the light reflective region, wherein, a reflection surface of the reflective layer adjacent to the first polarizer sheet is a flat surface, wherein, the reflective layer includes an opaque metal layer directly formed on the first polarizer sheet, and made by a method of coating, sputtering, evaporation or adhering; wherein, the reflection surface of the reflective layer is used to perform a specular reflection for an incident light which is incident to the reflection surface of the reflective layer, the incident light includes light enters to the color filter substrate and the reflective layer from an outside of the liquid crystal display panel, and the scattering layer is used to perform a diffuse reflection for a light reflected by the reflection surface of the reflective layer.

Wherein, a side of the array substrate adjacent to the liquid crystal layer is provided with a pixel electrode, a side of the color filter substrate adjacent to the liquid crystal layer is provided with a common electrode, and the common electrode and the pixel electrode are both disposed corresponding to the light reflective region and the light transmissive region.

Wherein, a side of the array substrate adjacent to the liquid crystal layer is provided with a pixel electrode and a common electrode, and the common electrode and the pixel electrode are both disposed corresponding to the light reflective region and the light transmissive region.

Wherein, the liquid crystal display panel further includes a second polarizer sheet disposed at a side of the color filter substrate, the second polarizer sheet has a same structure as the first polarizer sheet.

The liquid crystal display panel provided by the embodiment of the present invention includes: an array substrate and a color filter substrate which are disposed oppositely and at an interval, wherein, the array substrate includes multiple light reflective regions and multiple light transmissive regions disposed alternately; a liquid crystal layer disposed between the array substrate and the color filter substrate; a first polarizer sheet disposed at a side of the array substrate, and disposed corresponding to the light reflective region and the light transmissive region, wherein, the first polarizer sheet includes a polarizer base and a scattering layer; and a reflective layer located at a side of the first polarizer sheet away from the array substrate, and disposed corresponding to the light reflective region, wherein, a reflection surface of the reflective layer adjacent to the first polarizer sheet is a flat surface; wherein, the reflection surface of the reflective layer is used to perform a specular reflection for an incident light which is incident to the reflection surface of the reflective layer, the incident light includes light enters to the color filter substrate and the reflective layer from an outside of the liquid crystal display panel, and the scattering layer is used to perform a diffuse reflection for a light reflected by the reflection surface of the reflective layer.

Wherein, the reflective layer includes an opaque metal layer directly formed on the first polarizer sheet.

Wherein, the reflective layer includes a transparent base and a light reflective sheet, the light reflective sheet is formed on the transparent base, and the transparent base is fixed to the first polarizer sheet.

Wherein, the light reflective sheet includes an opaque metal layer.

Wherein, the reflective layer is made by a method of coating, sputtering, evaporation or adhering.

Wherein, a side of the array substrate adjacent to the liquid crystal layer is provided with a pixel electrode, a side of the color filter substrate adjacent to the liquid crystal layer is provided with a common electrode, and the common electrode and the pixel electrode are both disposed corresponding to the light reflective region and the light transmissive region.

Wherein, a side of the array substrate adjacent to the liquid crystal layer is provided with a pixel electrode and a common electrode, and the common electrode and the pixel electrode are both disposed corresponding to the light reflective region and the light transmissive region.

Wherein, the liquid crystal display panel further includes a second polarizer sheet disposed at a side of the color filter substrate, and the second polarizer sheet has a same structure as the first polarizer sheet.

The liquid crystal display device provided by the embodiment of the present invention includes: a liquid crystal display panel, and the liquid crystal display panel comprising: an array substrate and a color filter substrate which are disposed oppositely and at an interval, wherein, the array substrate includes multiple light reflective regions and multiple light transmissive regions disposed alternately; a liquid crystal layer disposed between the array substrate and the color filter substrate; a first polarizer sheet disposed at a side of the array substrate, and disposed corresponding to the light reflective region and the light transmissive region, wherein, the first polarizer sheet includes a polarizer base and a scattering layer; and a reflective layer located at a side of the first polarizer sheet away from the array substrate, and disposed corresponding to the light reflective region, wherein, a reflection surface of the reflective layer adjacent to the first polarizer sheet is a flat surface; wherein, the reflection surface of the reflective layer is used to perform a specular reflection for an incident light which is incident to the reflection surface of the reflective layer, the incident light includes a light enters to the color filter substrate and the reflective layer from an outside of the liquid crystal display panel, and the scattering layer is used to perform a diffuse reflection for a light reflected by the reflection surface of the reflective layer.

Wherein, the liquid crystal display device further includes a backlight module, the liquid crystal display panel further includes a second polarizer sheet disposed at a side of the color filter substrate, and the second polarizer sheet has a same structure as the first polarizer sheet, a backlight emitted from the backlight module emits to the first polarizer sheet, passing through the liquid crystal layer, and is incident to the second polarizer sheet.

Wherein, the reflective layer includes an opaque metal layer directly formed on the first polarizer sheet.

Wherein, the reflective layer includes a transparent base and a light reflective sheet, the light reflective sheet is formed on the transparent base, and the transparent base is fixed to the first polarizer sheet.

Wherein, the light reflective sheet includes an opaque metal layer.

Wherein, the reflective layer is made by a method of coating, sputtering, evaporation or adhering.

Wherein, a side of the array substrate adjacent to the liquid crystal layer is provided with a pixel electrode, a side of the color filter substrate adjacent to the liquid crystal layer is provided with a common electrode, and the common electrode and the pixel electrode are both disposed corresponding to the light reflective region and the light transmissive region.

Wherein, a side of the array substrate adjacent to the liquid crystal layer is provided with a pixel electrode and a common electrode, and the common electrode and the pixel electrode are both disposed corresponding to the light reflective region and the light transmissive region.

Comparing with the prior art, in the liquid crystal display device and the liquid crystal display panel of the same according to the embodiment of the present invention, designing a polarizer sheet disposed at a side of the array substrate and having a scattering layer, and adding a reflective layer at the light reflective region, and through the reflective layer to perform a specular reflection for an incident light, and the scattering layer to perform a diffuse reflection for a light reflected by the reflective layer in order to realize a specular and diffuse reflection effect. The present invention does not require adopting a photomask for manufacturing a concave and convex structure when manufacturing the reflective layer having the flat surface and the scattering layer so that the present invention can utilize less photomask processes to realize a transflective display effect so as to reduce the manufacturing processes and the manufacturing cost. Besides, the dimensional precision of the concave and convex structure for ensuring a diffuse reflection effect does not require considering so as to ensure the reflection effect.

### BRIEF DESCRIPTION OF THE DRAWINGS

FIG. 1 is a cross-sectional view of a liquid crystal display panel according to an embodiment of the present invention;

FIG. 2 is a cross-sectional view of a first polarizer sheet as shown in FIG. 1;

FIG. 3 is a cross-sectional view of a liquid crystal display panel according to another embodiment of the present invention; and

FIG. 4 is a cross-sectional view of a liquid crystal display device according to an embodiment of the present invention.

### DETAILED DESCRIPTION OF THE PREFERRED EMBODIMENT

The following content combines with the drawings and the embodiment for describing the present invention in detail.

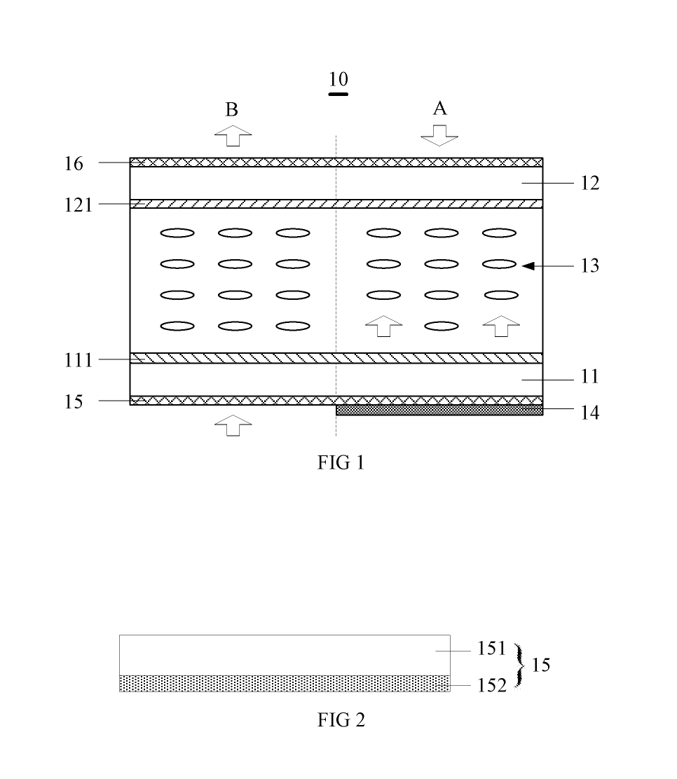

FIG. 1 is a cross-sectional view of a liquid crystal display panel according to an embodiment of the present invention. With reference to FIG. 1, a liquid crystal display panel 10 includes an array substrate (also known as a Thin-Film-Transistor substrate or a TFT substrate) 11 and a color filter substrate (CF substrate) 12 which are disposed oppositely and at an interval, and a liquid crystal layer 13 disposed between the array substrate 11 and the color filter substrate 12. Wherein, the liquid crystal layer 13 is located in a liquid crystal cell assembled and overlapped by the array substrate 11 and the color filter substrate 12.

The liquid crystal display panel 10 of the present embodiment is a transflective display panel, which has multiple light reflective regions A and multiple light transmissive regions B disposed alternately. It should be noted that FIG. 1 only shows one light reflective region A and one light transmissive region B adjacent to the one light reflective region A. As shown in FIG. 1, the difference comparing to the conventional art is a reflective layer 14 and a first polarizer sheet 15 disposed at the liquid crystal display panel 10.

Specifically, the first polarizer sheet 15 is disposed at a side of the array substrate 11, and disposed corresponding to the light reflective region A and the light transmissive regions B. With also reference to FIG. 2, the first polarizer sheet 15 includes a polarizer base 151 and a scattering layer 152, wherein the structure and the function of the polarizer base 151 is the same as the conventional polarizer sheet. The reflective layer 14 is located at a side of the first polarizer sheet 15 away from the array substrate 11, and disposed corresponding to the light reflective region A. A reflection surface of the reflective layer 14 adjacent to the first polarizer sheet 15 is a flat surface. In the present embodiment, the reflection surface of the reflective layer 14 is used to perform a specular reflection for an incident light (as shown by an arrow), and the scattering layer 152 is used to perform a diffuse reflection for a light reflected by the reflection surface of the reflective layer 14. Through the cooperation of the reflective layer 14 and the scattering layer 152 to realize the diffuse reflection for a light such that an observer can obtain an even reflection effect at a larger viewing angle so as to be beneficial for a wide viewing angle design.

Of course, the liquid crystal display panel 10 also includes a second polarizer sheet 16 located at a side of the color filter substrate 12. The second polarizer sheet 16 has a same structure as the first polarizer sheet 15.

Because the embodiment of the present invention does not require adopting a photomask for manufacturing a concave and convex structure when manufacturing the reflective layer 14 having the flat surface and the scattering layer 152, the present invention can utilize less photomask processes to realize a transflective display effect so as to reduce the manufacturing processes and the manufacturing cost. Besides, the dimensional precision of the concave and convex structure for ensuring a diffuse reflection effect does not require considering so as to avoid error and ensure the reflection effect.

The scattering layer 152 can be obtained through adding scattering particles in an outermost hardness coating layer of the first polarizer sheet 15. Of course the present invention is not limited. Besides, the light reflected by the reflection surface includes a light enters to the color filter substrate 12 and is incident on the reflective layer 14 from an outside of the liquid crystal display panel 10. The reflective layer 14 can be a light transmissive metal layer. The metal includes but not limited to aluminum, silver, and so on. Of course, the reflective layer 14 can be made of a material having a good reflective property.

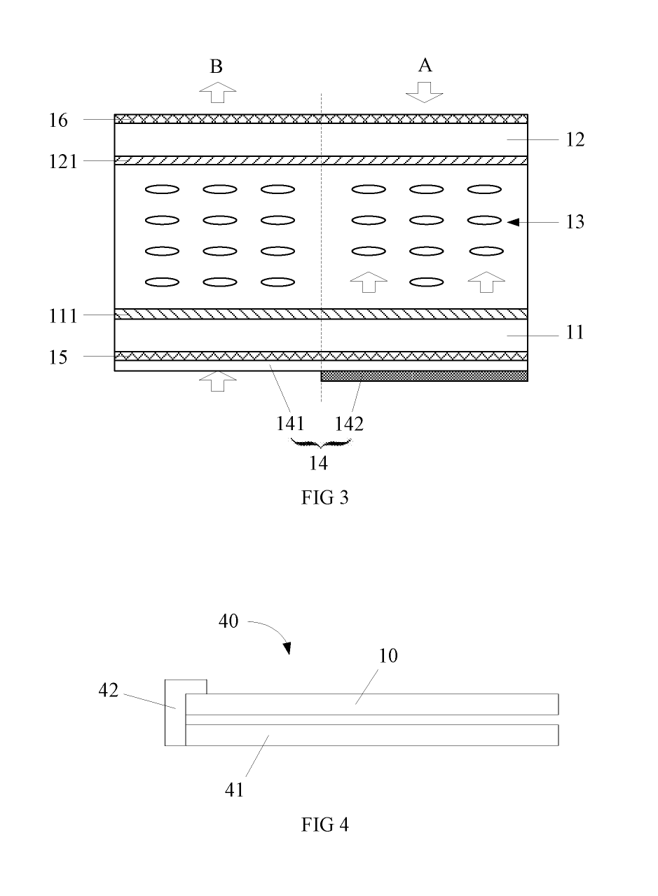

Furthermore, the reflective layer 14 can be disposed adjacent to the scattering layer 152 or adjacent to the polarizer base 151. Besides, the reflective layer 14 can be directly formed on the first polarizer sheet 15 or has a structure as shown in FIG. 3. As shown in FIG. 3, the reflective layer 14 includes a transparent base 141 and a light reflective sheet 142 forming on the transparent base 141. The transparent base 141 can be made by Polyethylene Terephthalate (PET), Polyethylene (PE), Polyvinyl Chloride (PVC) or other light transmissive material. The transparent base 141 is used to fix the light reflective sheet 142 to the first polarizer sheet 15. The light reflective sheet 142 is used to perform a specular reflection for an incident light. Wherein, the transparent base 141 can be disposed corresponding to the light reflective region A and the light transmissive regions B, or be disposed only corresponding to the light reflective region A.

Besides, the reflective layer 14 or the light reflective sheet 142 can be made by a method of coating, sputtering, evaporation or adhering, or any combination of the coating method, the sputtering method, the evaporation method and the adhering method. Of course, a chemical vapor deposition (CVD) method can also be adopted, and the present invention is not limited.

With reference to FIG. 1, the array substrate 11 includes a pixel electrode 111, and the color filter substrate 12 includes a common electrode 121. The common electrode 121 is a transparent electrode layer covering an entire surface of the color filter substrate 12. The pixel electrode 111 and the common electrode 121 are both disposed corresponding to the light reflective region A and the light transmissive region B. The meaning of “disposed corresponding to” is: The light reflective region A and the light transmissive region B are both provided with the pixel electrode 111 and the common electrode 121. A region size of the pixel electrode 111 is a sum of a region size of the light reflective region A and a region size of the light transmissive region B. A region size of the common electrode 121 is a sum of a region size of the light reflective region A and a region size of the light transmissive region B. In other words, the pixel electrode 111 and the common electrode 121 are both correspondingly located inside a region defined and limited by the light reflective region A and the light transmissive region B. The term “disposed corresponding to” of the full text of the invention can be understood according to above. For example, the reflective layer 14 is disposed corresponding to the light reflective region A can be understood as: the reflective layer 14 is correspondingly located inside a region defined and limited by the light reflective region A.

Of course, the design of the reflective layer 14 and the scattering layer 152 can also be applied to another liquid crystal display panel 10 having other structures. For example, the pixel electrode 111 and the common electrode 121 are both disposed on the array substrate 11. At this time, the pixel electrode 111 and the common electrode 121 are both disposed corresponding to the light reflective region A and the light transmissive region B.

The embodiment of the present invention also provides a liquid crystal display device 40 as shown in FIG. 4, which includes the liquid crystal display panel 10 as shown in FIG. 2 or FIG. 3, and other components such as a backlight module 41 and a front frame 42. Wherein, a backlight emitted from the backlight module 41 emits to the first polarizer sheet 15, passing through the liquid crystal layer 13, and is incident to the second polarizer sheet 16 in order to display an image. Because the liquid crystal display device 40 also have the above liquid crystal display panel 10. Therefore, the beneficial effects are the same. The liquid crystal display device 40 can be any terminal of a smart phone, a tablet computer, a television, or a navigation system, which has a display function.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A liquid crystal display panel, comprising
an array substrate and a color filter substrate which are disposed oppositely and at an interval, wherein, the array substrate includes multiple light reflective regions and multiple light transmissive regions disposed alternately;
a liquid crystal layer disposed between the array substrate and the color filter substrate;
a first polarizer sheet disposed at a side of the array substrate, and disposed corresponding to the light reflective region and the light transmissive region, wherein, the first polarizer sheet includes a polarizer base and a scattering layer; and
a reflective layer located at a side of the first polarizer sheet away from the array substrate, and disposed corresponding to the light reflective region, wherein, a reflection surface of the reflective layer adjacent to the first polarizer sheet is a flat surface, wherein, the reflective layer includes an opaque metal layer directly formed on the first polarizer sheet, and made by a method of coating, sputtering, evaporation or adhering;
wherein, the reflection surface of the reflective layer is used to perform a specular reflection for an incident light which is incident to the reflection surface of the reflective layer, the incident light includes light enters to the color filter substrate and the reflective layer from an outside of the liquid crystal display panel, and the scattering layer is used to perform a diffuse reflection for a light reflected by the reflection surface of the reflective layer.

2. The liquid crystal display panel according to claim 1, wherein, a side of the array substrate adjacent to the liquid crystal layer is provided with a pixel electrode, a side of the color filter substrate adjacent to the liquid crystal layer is provided with a common electrode, and the common electrode and the pixel electrode are both disposed corresponding to the light reflective region and the light transmissive region.

3. The liquid crystal display panel according to claim 1, wherein, a side of the array substrate adjacent to the liquid crystal layer is provided with a pixel electrode and a common electrode, and the common electrode and the pixel electrode are both disposed corresponding to the light reflective region and the light transmissive region.

4. The liquid crystal display panel according to claim 1, wherein, the liquid crystal display panel further includes a second polarizer sheet disposed at a side of the color filter substrate, the second polarizer sheet has a same structure as the first polarizer sheet.

5. A liquid crystal display panel, comprising
an array substrate and a color filter substrate which are disposed oppositely and at an interval, wherein, the array substrate includes multiple light reflective regions and multiple light transmissive regions disposed alternately;
a liquid crystal layer disposed between the array substrate and the color filter substrate;
a first polarizer sheet disposed at a side of the array substrate, and disposed corresponding to the light reflective region and the light transmissive region, wherein, the first polarizer sheet includes a polarizer base and a scattering layer; and
a reflective layer located at a side of the first polarizer sheet away from the array substrate, and disposed corresponding to the light reflective region, wherein, a reflection surface of the reflective layer adjacent to the first polarizer sheet is a flat surface;
wherein, the reflection surface of the reflective layer is used to perform a specular reflection for an incident light which is incident to the reflection surface of the reflective layer, the incident light includes light enters to the color filter substrate and the reflective layer from an outside of the liquid crystal display panel, and the scattering layer is used to perform a diffuse reflection for a light reflected by the reflection surface of the reflective layer.

6. The liquid crystal display panel according to claim 5, wherein, the reflective layer includes an opaque metal layer directly formed on the first polarizer sheet.

7. The liquid crystal display panel according to claim 5, wherein, the reflective layer includes a transparent base and a light reflective sheet, the light reflective sheet is formed on the transparent base, and the transparent base is fixed to the first polarizer sheet.

8. The liquid crystal display panel according to claim 7, wherein, the light reflective sheet includes an opaque metal layer.

9. The liquid crystal display panel according to claim 5, wherein, the reflective layer is made by a method of coating, sputtering, evaporation or adhering.

10. The liquid crystal display panel according to claim 5, wherein, a side of the array substrate adjacent to the liquid crystal layer is provided with a pixel electrode, a side of the color filter substrate adjacent to the liquid crystal layer is provided with a common electrode, and the common electrode and the pixel electrode are both disposed corresponding to the light reflective region and the light transmissive region.

11. The liquid crystal display panel according to claim 5, wherein, a side of the array substrate adjacent to the liquid crystal layer is provided with a pixel electrode and a common electrode, and the common electrode and the pixel electrode are both disposed corresponding to the light reflective region and the light transmissive region.

12. The liquid crystal display panel according to claim 5, wherein, the liquid crystal display panel further includes a second polarizer sheet disposed at a side of the color filter substrate, and the second polarizer sheet has a same structure as the first polarizer sheet.

13. A liquid crystal display device, wherein, the liquid crystal display device includes a liquid crystal display panel, and the liquid crystal display panel comprising:
an array substrate and a color filter substrate which are disposed oppositely and at an interval, wherein, the array substrate includes multiple light reflective regions and multiple light transmissive regions disposed alternately;
a liquid crystal layer disposed between the array substrate and the color filter substrate;
a first polarizer sheet disposed at a side of the array substrate, and disposed corresponding to the light reflective region and the light transmissive region, wherein, the first polarizer sheet includes a polarizer base and a scattering layer; and
a reflective layer located at a side of the first polarizer sheet away from the array substrate, and disposed corresponding to the light reflective region, wherein, a reflection surface of the reflective layer adjacent to the first polarizer sheet is a flat surface;
wherein, the reflection surface of the reflective layer is used to perform a specular reflection for an incident light which is incident to the reflection surface of the reflective layer, the incident light includes a light enters to the color filter substrate and the reflective layer from an outside of the liquid crystal display panel, and the scattering layer is used to perform a diffuse reflection for a light reflected by the reflection surface of the reflective layer.

14. The liquid crystal display device according to claim 13, wherein, the liquid crystal display device further includes a backlight module, the liquid crystal display panel further includes a second polarizer sheet disposed at a side of the color filter substrate, and the second polarizer sheet has a same structure as the first polarizer sheet, a backlight emitted from the backlight module emits to the first polarizer sheet, passing through the liquid crystal layer, and is incident to the second polarizer sheet.

15. The liquid crystal display device according to claim 13, wherein, the reflective layer includes an opaque metal layer directly formed on the first polarizer sheet.

16. The liquid crystal display device according to claim 13, wherein, the reflective layer includes a transparent base and a light reflective sheet, the light reflective sheet is formed on the transparent base, and the transparent base is fixed to the first polarizer sheet.

17. The liquid crystal display device according to claim 16, wherein, the light reflective sheet includes an opaque metal layer.

18. The liquid crystal display device according to claim 13, wherein, the reflective layer is made by a method of coating, sputtering, evaporation or adhering.

19. The liquid crystal display device according to claim 13, wherein, a side of the array substrate adjacent to the liquid crystal layer is provided with a pixel electrode, a side of the color filter substrate adjacent to the liquid crystal layer is provided with a common electrode, and the common electrode and the pixel electrode are both disposed corresponding to the light reflective region and the light transmissive region.

20. The liquid crystal display device according to claim 13, wherein, a side of the array substrate adjacent to the liquid crystal layer is provided with a pixel electrode and a common electrode, and the common electrode and the pixel electrode are both disposed corresponding to the light reflective region and the light transmissive region.
